(19) United States
(12) Patent Application Publication
(10) Pub. No.: US 2014/0352839 A1
(43) Pub. Date: Dec. 4, 2014

(54) POURING DEVICE WITH SCOOPING AND POURING FUNCTIONS

(71) Applicant: Ryan Caracciolo, Peoria, AZ (US)

(72) Inventor: Ryan Caracciolo, Peoria, AZ (US)

(21) Appl. No.: 13/906,286

(22) Filed: May 30, 2013

(51) Int. Cl. G01F 11/40

(52) U.S. Cl. CPC G01F 11/40
USPC 141/1; 141/331; 29/592

(57) ABSTRACT

An embodiment of a pouring device includes a storage section having a fill opening, a storage cavity, and a wall formed with a passage extending between an inner surface of the wall and an outer surface of the wall, includes a guide unit attached to the storage section, and includes a sliding unit configured to block the storage cavity, wherein the passage is configured to receive the sliding unit horizontally as it is moved along a first axis.

### CROSS REFERENCE TO RELATED APPLICATION

This application claims the benefit of priority from U.S. Provisional Application Ser. No. 61/653,231, which was filed on May 30, 2012, and which is expressly incorporated by reference herein in its entirety.

### BACKGROUND

Conventional systems for pouring may be difficult to use, or costly or complicated to manufacture, or difficult to keep clean.

For example, traditional scoops for powdered drinks may be found in bulk containers for powdered drinks. These scoops may be convenient for adding a measured amount of powdered drink mix to a container with an opening that is significantly larger than the mouth of the scoop, such as a mug or cup. However, for other containers with smaller openings, such as a water bottle, the traditional scoop may be too large to accurately pour drink mix through the container opening, resulting in messiness and wasted drink mixture.

Other conventional devices may be inconveniently shaped, or may dispose moving parts next to or within a container opening, which may increase cleaning difficulty.

Accordingly, improvements may be made with respect to conventional pouring and/or measuring systems.

### BRIEF DESCRIPTION OF THE DRAWINGS

FIG. 1 is a perspective view of the pouring device, according to an embodiment;

FIG. 2 is an additional perspective view of the pouring device with dashed lines, according to an embodiment;

FIG. 3 is a side view of the pouring device with the sliding unit at an open position, according to an embodiment;

FIG. 4 is a top view of the pouring device, according to an embodiment;

FIGS. 5 and 6 are side views of the pouring device with the sliding unit at a closed position, according to an embodiment;

FIG. 7 is a bottom view of the pouring device with the sliding unit at a closed position, according to an embodiment; and

FIG. 8 is a front view of the pouring device, according to an embodiment.

### DETAILED DESCRIPTION OF THE INVENTION

Disclosed are a device, method, and article of manufacture for household scooping and pouring. Although the present embodiments have been described with reference to specific example embodiments, it will be evident that various modifications and changes may be made to these embodiments without departing from the broader spirit and scope of particular example embodiments.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of structures, openings, protrusions, surfaces, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

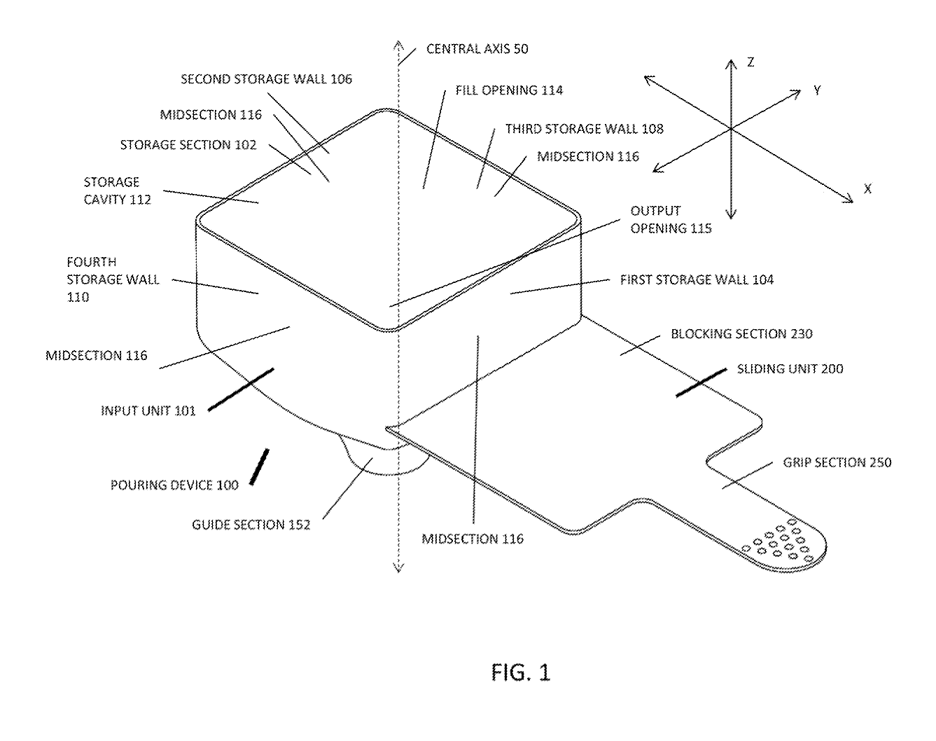

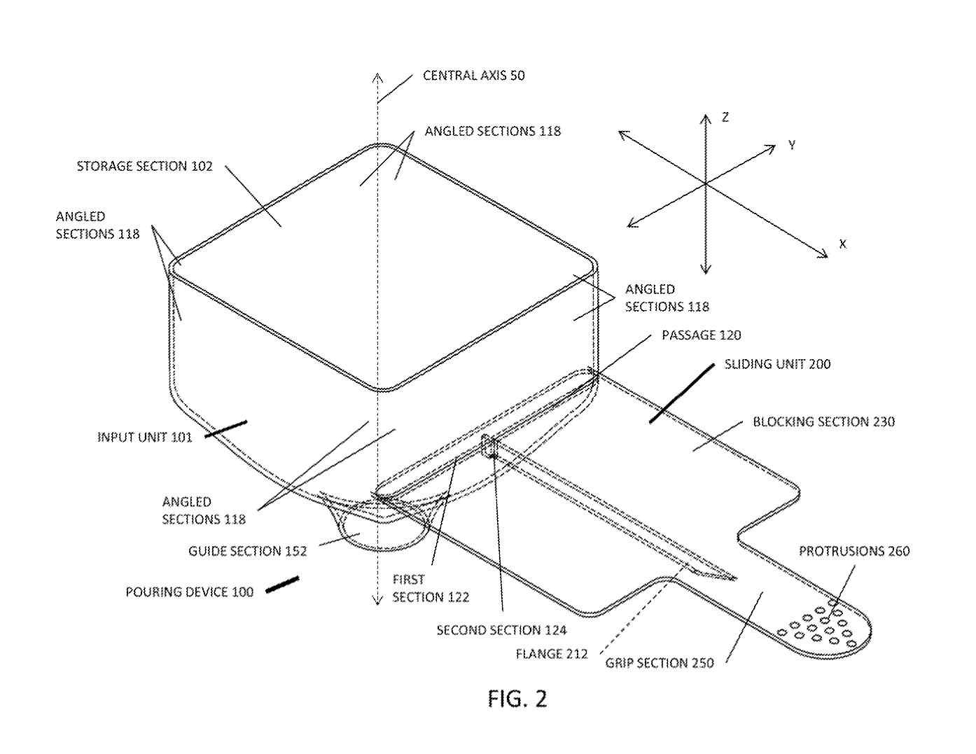

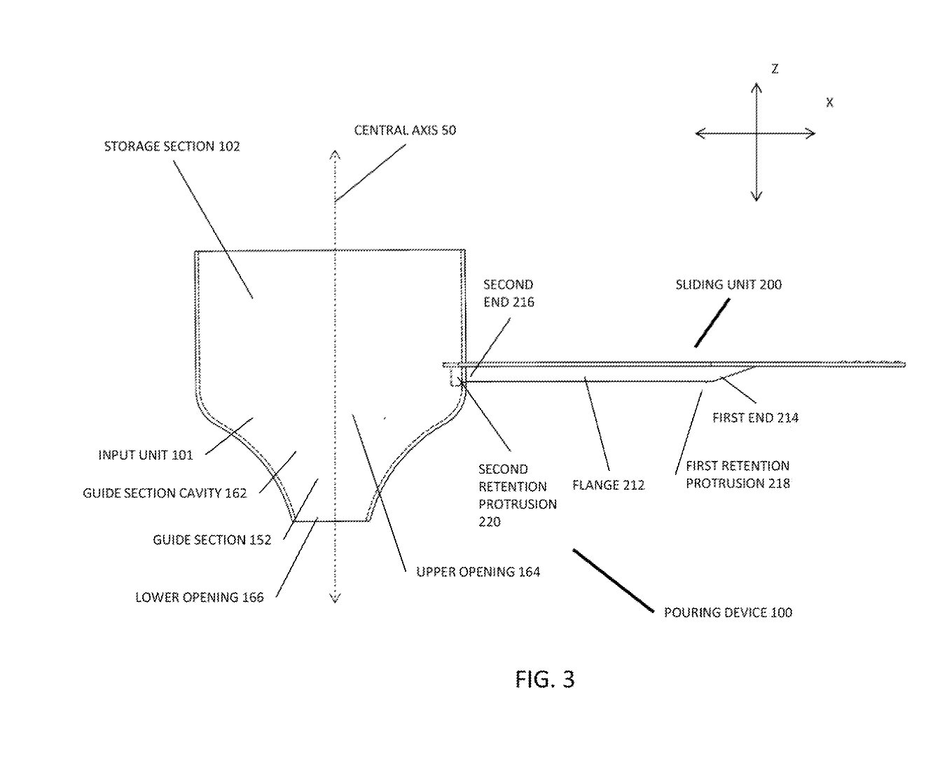

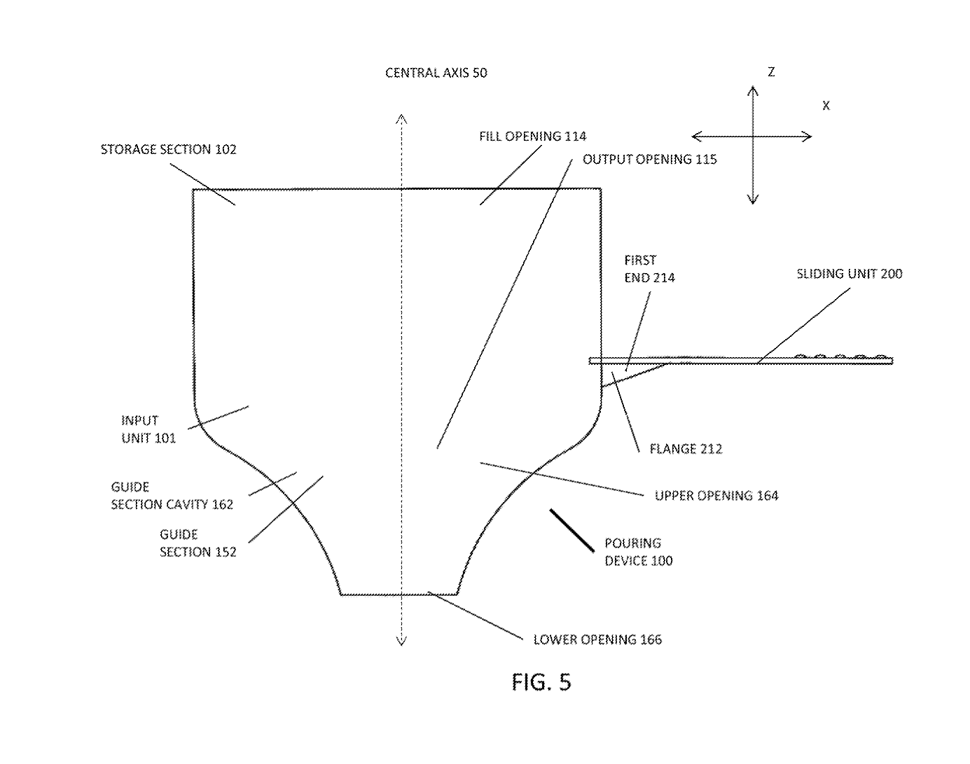

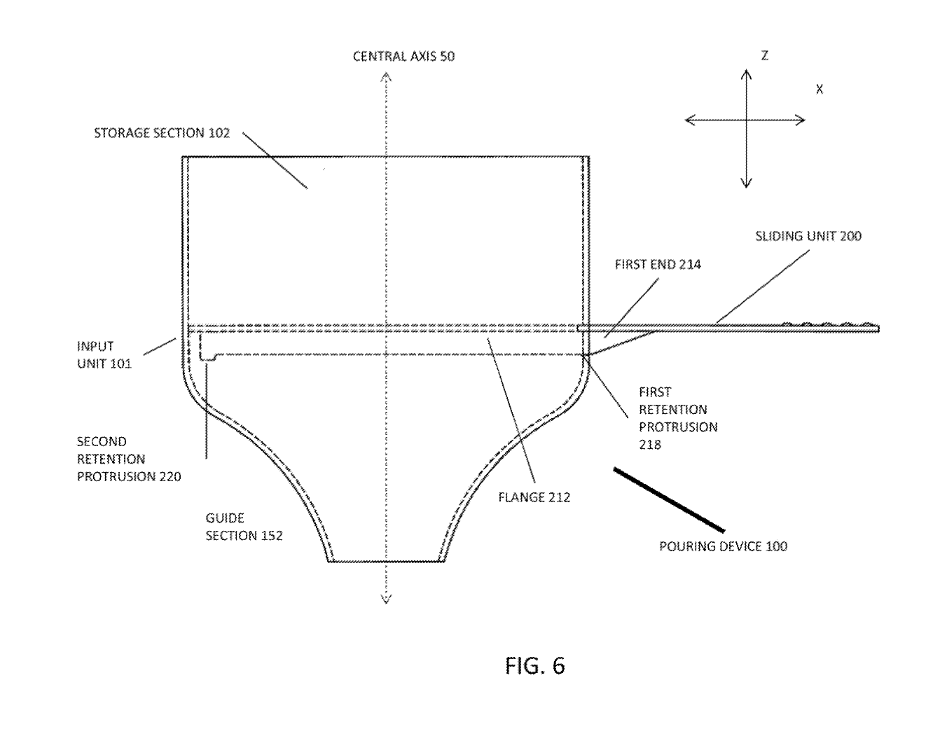

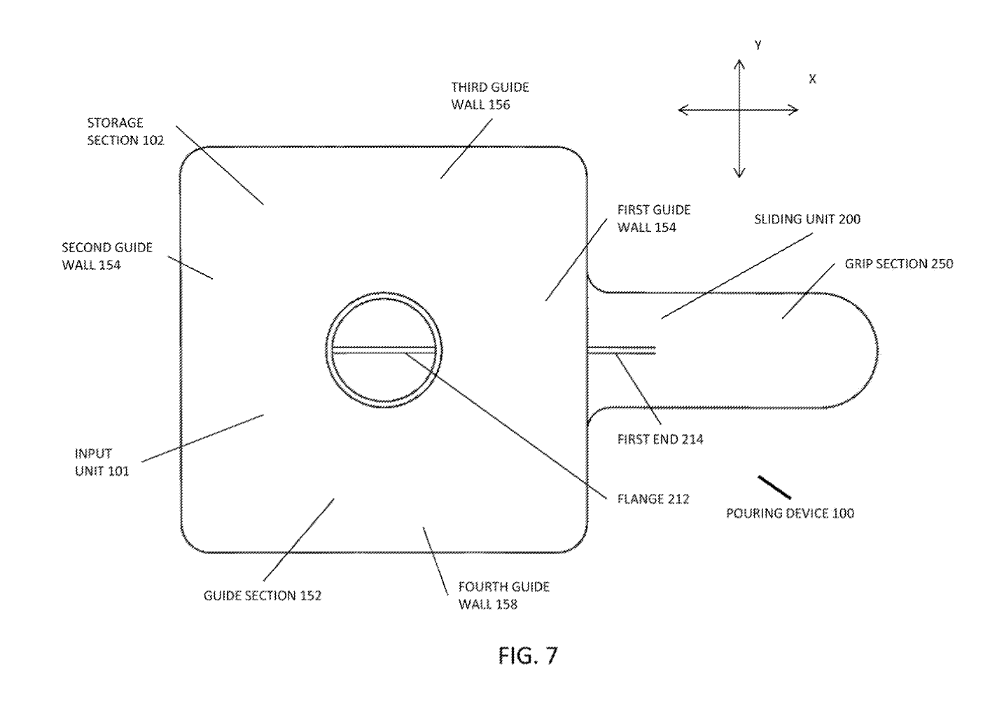

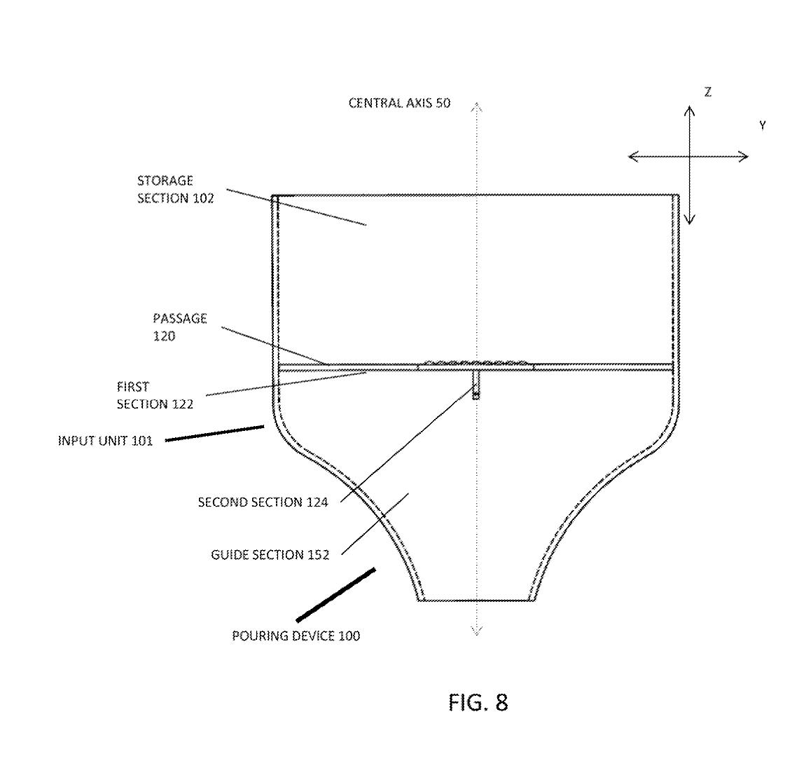

FIGS. 1 and 2 are perspective views of the pouring device 100, according to an embodiment. The pouring device 100 may include an input unit 101 (e.g., an input member) and a sliding unit 200 (e.g., a sliding member). The pouring device 100 may be used with one hand to reach into a container of powder and/or liquid, and to scoop out a measured amount. The pouring device 100 may then be disposed above a container to be filled with the measured powder or liquid, and a user may grip the sliding unit 200, and pull it laterally away from a center axis of the input unit 101. By moving the sliding unit 200, the powder or liquid may be permitted to fall from an upper section of the input unit 101 to a lower section of the input unit 101 to be guided into the container to be filled. When sufficient powder or liquid has been dispensed, the user may push the sliding unit 200 back into the input unit 101. FIGS. 3-8 include additional views of the device, and are described in greater detail below.

### Input Unit

FIGS. 1-8 are perspective, side, top, front, and bottom views of the pouring device 100 with the sliding unit 200 at open and closed positions, according to various embodiments. As shown in FIGS. 1-8, the input unit 101 may include a storage section 102, and a guide section 152 connected to the storage section 102. The input unit 101 may include a central axis 50 that extends parallel to a Z-axis.

### Input Unit: Storage Section

The storage section 102 may be configured to function as a scoop, and may be sized to accommodate a measured amount of a powder or liquid. The storage section 102 may be rectangular, and include four walls: a first storage wall 104, a second storage wall 106, a third storage wall 108, and a fourth storage wall 110. In other embodiments, the storage section 102 may include additional or fewer walls. Each of the walls of the storage section 102 may extend along the central axis 50 (e.g., parallel to the Z-axis) of the input unit 101, and the walls of the storage section 102 may collectively surround the central axis 50. The storage section 102 may include a fill opening 114 that receives powder being scooped by the device, and an output opening 115 that mates with an upper opening 164 of the guide section 152. The four walls of the storage section 102 may define a storage cavity 112 that extends between the fill opening 114 and the output opening 115.

The rectangular shape of an embodiment of the storage section 102 may permit the scoop to be used to reach into corners of a drink mix container, and may assist with scooping powder from the bottom of the drink mix container when a flat side of the storage section 102 is abutted flush against a flat surface of the drink mix container.

The first storage wall 104 and the second storage wall 106 may each include a midsection 116 that is substantially parallel to the Y-Z plane (e.g., a plane defined by the Y-axis and the Z-axis that is perpendicular to the X-axis). The first storage wall 104 and the second storage wall 106 may each include angled sections 118 disposed at the lateral sides of the midsections 116 of the first storage wall 104 and the second storage wall 106. The angled sections 118 may extend from the lateral sides of the midsection 116 along the Y-axis away from the midsection 116 and along the X-axis towards the central axis 50 of the input unit 101.

The third storage wall 108 and the fourth storage wall 110 may each include a midsection 116 that is substantially parallel to the X-Z plane (e.g., a plane defined by the X-axis and the Z-axis that is perpendicular to the Y-axis). The third storage wall 108 and the fourth storage wall 110 may each include angled sections 118 disposed at the lateral sides of the midsections 116 of the third storage wall 108 and the fourth storage wall 110. The angled sections 118 may extend from the lateral sides of the midsections 116 along the X-axis away from the midsection 116 and along the Y-axis towards the central axis 50 of the input unit 101.

The first storage wall 104, the second storage wall 106, the third storage wall 108, and the fourth storage wall 110 may each extend substantially parallel to the Z-axis.

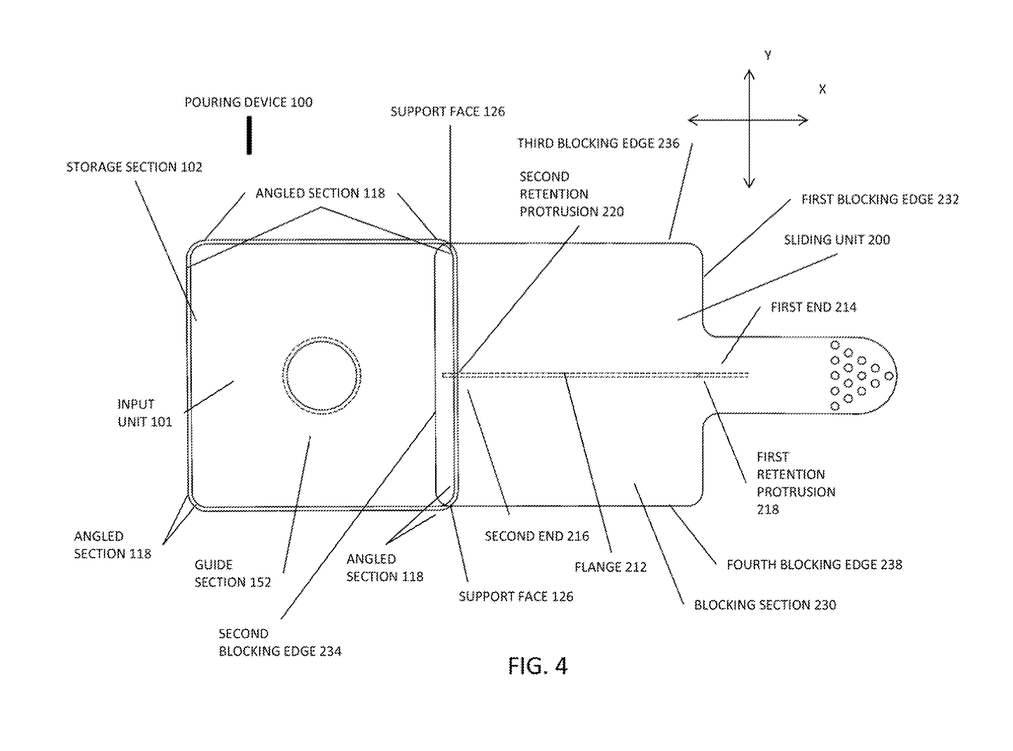

As shown in FIGS. 2 and 4, the angled sections 118 may be curved. In other embodiments, the angled sections 118 may be flat or have other forms and/or surfaces. The midsections 116 of the first storage wall 104 and the second storage wall 106 may be substantially parallel to each other, and the midsections 116 of the third storage wall 108 and the fourth storage wall 110 may be substantially parallel to each other.

The first storage wall 104 may define a passage 120 that extends between an exterior face and an inner face of the first storage wall 104, and that is in fluid communication with the storage cavity 112. The passage 120 may be configured to receive insertion of the sliding unit 200 along the X-axis. The sliding unit 200 may be extended through the first storage wall 104 along the X-axis and between the third storage wall 108 and the fourth storage wall 110 until the sliding unit 200 is abutted against the second storage wall 106. When sufficiently extended into the storage section 102, the sliding unit 200 may cover the output opening 115 of the storage section 102.

The passage 120 may extend between an exterior face and an interior face of the first storage wall 104 along the X-axis. The passage 120 may include an elongate first section 122 extending laterally across the first storage wall 104 along the Y-axis. The first section 122 may extend across the midsection of the first storage wall 104 and across at least a portion of each of the angled sections 118 of the first storage wall 104. The passage 120 may also include an elongate second section 124 extending downward along the Z-axis away from the first section 122. The first section 122 and the second section 124 may form a T-shaped opening, and the width of the second section 124 along the Y-axis may be similar to the width of the first section 122 along the Z-axis.

The portions of the angled sections 118 of the first storage wall 104 that define part of the upper and lower boundaries of the passage 120 may be angled support faces 126 that extend along the Y-axis away from the midsection 116 and along the X-axis towards the central axis 50 of the input unit 101. The support faces 126 may be disposed at the bottom and top surfaces (e.g., along the Y-axis) of the first section 122 of the passage 120. The angled support faces 126 may provide rotational support for the sliding unit 200 that restricts rotation around the Y-axis.

### Input Unit: Guide Section

The guide section 152 may be configured to receive the measured amount of powder or liquid when the sliding unit 200 is extracted along the X-axis through the passage 120 that extends through the first storage wall 104 of the storage section 102. The guide section 152 may include a first guide wall 154, a second guide wall 156, a third guide wall 158, and a fourth guide wall 160. The walls of the guide section 152 may cooperate to form an upper opening 164 that is rectangular and that mates with the output opening 115 of the input unit 101. The walls of the guide section 152 may further cooperate to define a lower opening 166 that is circular through which powder or liquid may be dispensed. The walls of the guide section 152 may further define a guide section cavity 162 that extends along the Z-axis between the upper opening 164 and the lower opening 166. Each wall of the guide section 152 may extend inward in the X-Y plane towards the central axis 50 as each wall of the guide section 152 extends downward away from the storage section 102.

### Sliding Unit

The sliding unit 200 may be configured to be inserted through the passage 120 disposed in the first storage wall 104 of the storage section 102 and extended along the X-axis towards the second storage wall 106. The sliding unit 200 may include a blocking section 230 and a grip section 250.

### Sliding Unit: Blocking Section

As shown in FIGS. 1-8, the blocking section 230 of the sliding unit 200 may extend along the X-axis and Y-axis, and may be configured to cover the storage cavity 112 when sufficiently extended into the storage section 102 of the input unit 101. The blocking section 230 may be moved out from the input unit 101 along the X-axis to permit powder or liquid in the storage section 102 to flow into the guide section 152 of the input unit 101.

The blocking section 230 may include a rectangular wall that is sized to fit between the third storage wall 108 and the fourth storage wall 110 sufficiently tightly to prevent excessive leakage. The rectangular wall may include a first blocking edge 232, a second blocking edge 234, a third blocking edge 236, and a fourth blocking edge 238. The first blocking edge 232 and the second blocking edge 234 may extend along the Y-axis, and the third blocking edge 236 and the fourth blocking edge 238 may extend along the X-axis. When the blocking section 230 has been sufficiently inserted into the storage section 102 to block the storage cavity 112, the first blocking edge 232, the second blocking edge 234, the third blocking edge 236, and the fourth blocking edge 238 may be disposed near or against the first storage wall 104, the second storage wall 106, the third storage wall 108, and the fourth storage wall 110, respectively. In some embodiments, the second blocking wall may be abutted against an inner face of the second storage wall 106 to block off the storage cavity 112.

The blocking section 230 may include a grip section 250 that is co-planar with and integrally formed with the rectangular wall. The grip section 250 may extend from the rectangular wall along the X-axis away from the storage section 102. The grip section 250 may be narrower along the Y-axis than the rectangular wall, and may have substantially the same thickness along the Z-axis as the rectangular wall.

The sliding unit 200 may include a flange 212 that extends downward from the rectangular wall along the Z-axis and substantially the length of the blocking section 230 along the X-axis. The flange 212 may have a first end 214 disposed proximate to the first blocking edge 232, and a second end 216 disposed proximate to the second blocking edge 234. The second blocking edge 234 may extend past the second end 216 of the flange 212 along the X-axis, which may assist with insertion of the blocking section 230 into the passage 120 formed in the first storage wall 104. For example, a second blocking edge 234 that extends past the second end 216 of the flange 212 may permit the sliding unit 200 to be aligned with and inserted into the first section 122 of the passage 120 even if the flange 212 is not aligned in the X-axis direction with the second section 124 of the passage 120. The user may then align the flange 212 of the sliding unit 200 along the Y-axis with the second section 124 of the passage 120 to permit insertion of the sliding unit 200 into the storage section 102 of the input unit 101.

The flange 212 may be formed with a first retention protrusion 218 that extends downward along the Z-axis away from the first end 214 of the flange 212. The flange 212 may be formed with a second retention protrusion 220 that extends downward along the Z-axis from the second end 216 of the flange 212. The second retention protrusion 220 may be substantially larger than the first retention protrusion 218 as measured along the X-axis and the Z-axis.

The second retention protrusion 220 may make it more difficult to accidentally separate the sliding unit 200 from the input unit 101 when allowing powder or liquid to fall through the storage section 102 and the sliding unit is at an open position. For example, when the sliding unit 200 is being extracted along the X-axis from the input unit 101, the second retention protrusion 220 may extend past the a lower end of the second section 124 of the passage 120, hooking onto the first storage wall 104 and restricting further movement of the sliding unit 200. The first retention protrusion 218 may help retain the sliding unit 200 at a blocking position within the input unit 101.

The first end 214 of the flange 212 may extend onto the grip section 250, and may taper in the Z-axis direction as the flange 212 extends along the X-axis away from the second end 216 of the flange 212.

### Sliding Unit: Grip Section

As shown in FIG. 2 and other figures, the grip section 250 may include one or more protrusions 260 and/or recesses integrally formed with or attached to the grip section 250. The protrusions 260 and/or recesses may enable additional friction for a user's thumb or finger when the grip section 250 is being pinched by a user holding the grip section 250.

### CONCLUSION

Although the present embodiments have been described with reference to specific example embodiments, various modifications and changes can be made to these embodiments without departing from the broader spirit and scope of the various embodiments.

What is claimed is:

1. A pouring device, comprising:
a storage section having a fill opening, a storage cavity, and a wall formed with a passage extending between an inner surface of the wall and an outer surface of the wall;
a guide unit attached to the storage section; and
a sliding unit configured to block the storage cavity, wherein the passage is configured to receive the sliding unit horizontally as it is moved along a first axis.

2. The device of claim 1, wherein the fill opening is rectangular, the device further comprising a second wall having a flat exterior surface configured for being abutted against flat surfaces.

3. The device of claim 1, wherein the sliding unit comprises a blocking section shaped to conform to the interior dimensions of the storage cavity defined by the storage section.

4. The device of claim 3, wherein the blocking section includes a leading edge configured to abut against the interior surface when the sliding unit is fully extended into the storage section to block the storage cavity such that the pouring device is configured to operate as a scoop.

5. The device of claim 4, wherein the blocking section includes a pair of lateral edges configured to abut slidingly against an interior surface of each of the lateral walls of the storage cavity as the sliding unit is moved horizontally through the passage.

6. The device of claim 3, wherein the blocking section includes a wall that extends horizontally along the first axis and a second horizontal axis that is perpendicular to the first axis.

7. The device of claim 3, wherein the sliding unit includes a flange that extends vertically from the blocking section and horizontally along the first axis.

8. The device of claim 7, wherein a leading surface of the blocking section extends past a leading end of the flange to comprise a vertical alignment section configured to facilitate insertion of the sliding unit into the input unit.

9. The device of claim 7, wherein the flange includes a first protrusion configured to retain the sliding unit within the storage section when the sliding unit is at an open position that permits fluid communication between an upper part the storage section and the guide section, and the sliding unit is being pulled horizontally out of the storage section through the passage.

10. The device of claim 9, wherein the flange includes a first protrusion configured to retain the sliding unit within the storage section when the sliding unit is at a closed position such that the storage cavity is blocked and prevents fluid communication between an upper part the storage section and the guide section, and the sliding unit is being pulled horizontally out of the storage section through the passage.

11. The device of claim 1, wherein the wall formed with the passage includes a midsection and a pair of angled sections disposed at lateral sides of the midsection, and the passage extends laterally through each of the angled sections.

12. The device of claim 11, wherein each of the angled sections extends away from the respective lateral sides of the midsection along a second axis that is horizontal and perpendicular to the first axis while extending along the first axis toward a central vertical axis of the storage section.

13. The device of claim 12, wherein the angled sections include angled support faces that define vertically facing surfaces that extend along the first axis toward a central vertical axis of the storage section while extending away from the respective lateral sides of the midsection along a second axis that is horizontal and perpendicular to the first axis.

14. The device of claim 13, wherein the vertically facing surfaces of the angled sections provide rotational support for the sliding unit around a second axis that is horizontal and perpendicular to the first axis.

15. The device of claim 1, wherein the passage includes a first elongate section that extends horizontally, and a second elongate section that extends vertically.

16. A pouring device manufacturing method, comprising:
building a storage section having a fill opening, a storage cavity, and a wall formed with a passage extending between an inner surface of the wall and an outer surface of the wall;
forming a guide unit attached to the storage section; and
forming a sliding unit configured to block the storage cavity, wherein the passage is configured to receive the sliding unit horizontally as it is moved along a first axis.

17. The device of claim 16, wherein the fill opening is rectangular, the device further comprising a second wall having a flat exterior surface configured for being abutted against flat surfaces.

18. The device of claim 16, wherein the sliding unit comprises a blocking section shaped to conform to the interior dimensions of the storage cavity defined by the storage section.

19. The device of claim 18, wherein the blocking section includes a leading edge configured to abut against the interior surface when the sliding unit is fully extended into the storage section to block the storage cavity such that the pouring device is configured to operate as a scoop.

20. A pouring device method, the pouring device comprising a storage section having a fill opening, a storage cavity, and a wall formed with a passage extending between an inner surface of the wall and an outer surface of the wall, the pouring device further comprising a guide unit attached to the storage section, and further comprising a sliding unit configured to block the storage cavity, wherein the passage is configured to receive the sliding unit horizontally as it is moved along a first axis, the pouring device method comprising:
filling the storage section with powder through the fill opening when the sliding unit is blocking the storage cavity;
holding the storage section in place above a drink container with one hand; and
driving the sliding unit horizontally such that the sliding unit does not completely block the storage cavity.
